(19) United States
(12) Patent Application Publication
(10) Pub. No.: US 2020/0286042 A1
(43) Pub. Date: Sep. 10, 2020

(54) MANAGEMENT METHOD AND SYSTEM FOR DETAILED ENGINEERING OF PLANT PROJECTS

(71) Applicant: POSTECH Research and Business Development Foundation, Pohang-si (KR)

(72) Inventors: Eul Bum LEE, Pohang-si (KR); Myung Hun KIM, Ulsan-si (KR)

(21) Appl. No.: 16/812,230

(22) Filed: Mar. 6, 2020

(30) Foreign Application Priority Data
Mar. 8, 2019 (KR) 10-2019-0027060

(51) Int. Cl. G06Q 10/10; G06Q 50/04; G06Q 50/08; G06Q 50/16; G06Q 50/18; G06Q 10/08; G06Q 10/06; G06Q 10/04; G06N 5/04; G06F 30/20

(52) U.S. Cl. CPC G06Q 10/103; G06Q 50/04; G06Q 50/08; G06Q 50/165; G06Q 50/18; G06Q 10/1093; G06F 30/20; G06Q 10/06375; G06Q 10/06312; G06Q 10/04; G06Q 10/06313; G06N 5/04; G06Q 10/0875

(57) ABSTRACT

Provided are a management method, system and program for detailed engineering of a plant project. The management method includes: determining a start date for a process of a project; preparing an engineering maturity assessment data including index data; determining a key milestone schedule; calculating a first engineering maturity assessment score at a contract time; comparing the first engineering maturity assessment score with a reference value, calculating a second engineering maturity assessment score at a key milestone time; comparing the second engineering maturity assessment score with a second reference value; calculating a third engineering maturity assessment score at the start date; and comparing the third engineering maturity assessment score with a third reference value, wherein the process is performed according to the start date for the project process if the third engineering maturity assessment score is less than the third reference value.

### BACKGROUND

### 1. Field

The present disclosure relates to a management method for plant projects, and more particularly, to a method and system for effectively managing a schedule of plant projects by procuring index items that may affect the plant projects and reflecting a statistical technique on the procured index items.

### 2. Description of Related Art

Engineering, procurement and construction (EPC) refers to a project that a performing company wins a contract on construction of a building or plant such as power plants, port docks, factories, oil drilling ships, and the like as a lump-sum turnkey from engineering to fund raising and construction and delivers a finally complete plant or building to an ordering company.

Here, the performing company of the plant project finalize a total cost for construction and a construction period for the ordering company, and in the process of plant construction, process delays may occur frequently due to natural or human causes. As a result, the performing company may need to consider risks of not only increasing construction costs due to the process delay but also failing to meet the construction period, which may cause damage due to construction delays.

In order to solve the problems, a method for managing a construction schedule has been proposed. For example, Korean Patent Laid-Open Publication No. 10-2013-0023670 (Marine Equipment Break Point Management System) discloses a notification of schedule delays when a delay occurs in a schedule transmitted from each department related to the construction of an offshore structure. Patent Application Publication No. 10-2013-0082999 (Marine Piping Process Management System) discloses a process of determining whether a process status input for each unit process of a marine piping process complies with a predetermined schedule and provides corresponding information to a manager. In addition, Korean Patent Registration No. 10-1073256 (System and Method for Managing Production of Shipbuilding) discloses a system for receiving and managing process status information for each production organization related to shipbuilding in real time.

However, in the related art, in the process of construction of a plant such as a marine facility or a vessel, a related department directly registers an expected schedule as needed and manage the entire schedule depending on an arbitrarily registered expected schedule, feasibility of the registered schedule cannot be confirmed and reviewed in advance from a schedule establishment stage.

### RELATED ART DOCUMENT

### Patent Document

Korean Patent Laid-open Publication No. 10-2013-0023670 (2013.03.08)
Korean Patent Laid-open Publication No. 10-2013-0082999 (2013.07.22)
Korean Patent Registration No. 10-1073256 (2011.10.12)

### Non-Patent Document

Document Project Readiness by Estimate Class. AACE International Transactions. 2011.
Nerve Baron. Oil & Gas Engineering Guide. Second Edition. Editions Technip. 2015.
Gibson, George E., Project Definition Rating Index (PDRI). Bureau of Engineering Research, University of Texas at Austin, 1996.
Bingham, Evan. Development of the project definition rating index (PDRI) for infrastructure projects, Arizona State University, 2010.
Wesley A. Collins. Development of the Project Definition Rating Index (PDRI) for Small Industrial Projects, Arizona State University, 2015.

### SUMMARY

Therefore, an aspect of the detailed description is to provide management method and system for detailed engineering of plant project, capable of effectively executing plant project by selecting index elements that affect completion of a plant from design to completion and forecasting loss in cost or delay in period due to an increase in manufacturing time by utilizing the selected index elements.

Another aspect of the detailed description is to provide a system that provides a forecast and mitigation model of schedule and cost performance during a detailed engineering stage of a plant project.

The objects to be achieved in the present disclosure are not limited to the objects mentioned above, and other objects not mentioned above are apparent to those skilled in the art to which the present disclosure pertains, from the following description.

To achieve these and other advantages and in accordance with the purpose of this specification, as embodied and broadly described herein, a management method for detailed engineering of a plant project in a method of managing a project in a system for managing a schedule after a contract time of a plant project includes: determining a start date for a process of the project; preparing an engineering maturity assessment data including index data; finalizing a key milestone schedule; calculating a first engineering maturity assessment score at the contract time; comparing the first engineering maturity assessment score with a reference value, calculating a second engineering maturity assessment score at the key milestone time; comparing the second engineering maturity assessment score with a second reference value; calculating a third engineering maturity assessment score at the start date; and comparing the third engineering maturity assessment score with a third reference value, wherein the process is performed according to the start date for the project process if the third engineering maturity assessment score is less than the third reference value.

The key milestone time may include a first key milestone time six months after the contract time, a second key milestone time nine months after the contract time, and a third key milestone time 12 months after the contract time.

The calculating of the second engineering maturity assessment score and the comparing of the second engineering maturity assessment score with the second reference value at the first key milestone time may include: calculating a fourth engineering maturity assessment score at the first key milestone time; comparing the fourth engineering maturity assessment score with a fourth reference value; calculating a fifth engineering maturity assessment score at the second key milestone time; comparing the fifth engineering maturity assessment score with a fifth reference value; calculating a sixth engineering maturity assessment score at the third key milestone time; and comparing the sixth engineering maturity assessment score with a sixth reference value.

The management method may further include: increasing a design man-hour after at least one of the steps of comparing the assessment scores and the reference values.

The first reference value may be 810 points, the fourth reference value may be 660 points, the fifth reference value may be 500 points, and the sixth reference value may be 380 points.

The reference values may be calculated based on data including a basis of detail design section, an engineering deliverables section, and an execution approach section.

The basis of detail design section may include a category of a project scope, a project performance requirement, and a design guideline.

The engineering deliverables section may include process/mechanical/piping, equipment vendor, structural and architectural, instrument and electrical, material take-off, 3D modeling, and general facility requirement category.

The execution approach section may include an engineering project management and project execution plan category.

The category may include each of a plurality of index elements reflecting characteristics of the category, the index elements may be divided into a plurality of stages different in level, and each level may be given a weight according to the index elements.

The weight may be normalized such that an assessment score for the entire index elements is a maximum of 1,000.

The third reference value may be 300 points.

The management method may further include increasing design man-hour such as increasing manpower input time.

To achieve these and other advantages and in accordance with the purpose of this specification, as embodied and broadly described herein, a management system for detailed engineering of a plant project in a system for managing a schedule of a plant project includes: a data management module managing index data for assessing engineering maturity for the plant project; an assessment module assessing engineering maturity of the plant project based on the index data and managing a corresponding result; and a schedule management module changing or managing a start date for a project process according to the assessment result, wherein the index data includes a plurality of index elements, each index element is divided into a plurality of stages different in level, and each level is given a weight according to the index elements.

To achieve these and other advantages and in accordance with the purpose of this specification, as embodied and broadly described herein, a management program for detailed engineering of a plant project, in a system for managing a schedule of a plant project, stored in a medium to execute: determining a start date for a process of the project; preparing an engineering maturity assessment data including index data; finalizing a key milestone schedule; calculating a first engineering maturity assessment score at the contract time; comparing the first engineering maturity assessment score with a reference value, calculating a second engineering maturity assessment score at the key milestone time; comparing the second engineering maturity assessment score with a second reference value; calculating a third engineering maturity assessment score at the start date; and comparing the third engineering maturity assessment score with a third reference value, wherein the process is performed according to the start date for the project process if the third engineering maturity assessment score is less than the third reference value.

Details of other embodiments are included in the detailed description and drawings.

### BRIEF DESCRIPTION OF DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a conceptual diagram of a management method for detailed engineering of a plant project according to an embodiment of the present disclosure.

FIGS. 2 to 5 are views showing index elements selected for use in assessing engineering maturity of a plant project in a management method for detailed engineering of a plant project according to an embodiment of the present disclosure.

FIGS. 6(a) and 6(b) are diagrams each showing a weight distribution in a case where weights are assigned to index elements in a management method for detailed engineering of a plant project according to the embodiment of the present disclosure.

FIG. 7 is an diagram of an assessment sheet in which a weight is assigned to each index element belonging to a Basis of Detail Design section in a management method for detailed engineering of a plant project according to an embodiment of the present disclosure.

FIG. 8 is a diagram showing data of an existing case collected to verify feasibility of index data in a management method for detailed engineering of a plant project according to an embodiment of the present disclosure.

FIGS. 9(a) and 9(b) are diagrams showing results of performing an engineering maturity assessment of existing cases using a management method for detailed engineering of a plant project according to an embodiment of the present disclosure.

FIGS. 10(a), 10(b) and 10(c) are diagrams showing results of performing verification on a construction labor hour increase rate (CLIR) based on steel cutting corresponding to a start point of a plant project in a management method for detailed engineering of a plant project according to an embodiment of the present disclosure.

FIGS. 11(a), 11(b) and 11(c) are diagrams showing results of performing verification on a construction duration delay (CDD) based on steel cutting corresponding to a start time of a plant project in a management method for detailed engineering of a plant project according to an embodiment of the present disclosure.

FIG. 12 is a graph illustrating a correlation between detailed engineering completion rating index system (DECRIS) scores as engineering maturity assessment results and construction manhour increase rates (CMIR) of existing cases, in a management method for detailed engineering of a plant project according to an embodiment of the present disclosure.

FIG. 13 is a diagram showing a correlation between DECRIS scores as engineering maturity assessment results and CDD of existing cases, in a management method for detailed engineering of a plant project according to an embodiment of the present disclosure.

FIG. 14 is a table showing comparison between results of applying a management method for detailed engineering of a plant project according to an embodiment of the present disclosure to a currently ongoing plant project and forecasted process values at a corresponding time.

FIG. 15 is a graph showing DECRIS scores of reference based on a key milestone schedule according to an embodiment of the present disclosure.

FIG. 16 is an algorithm flowchart illustrating a method of designating a start time of execution approach according to an embodiment.

FIG. 17 is a flowchart specifically illustrating steps of calculating a score and using a recovery strategy at a key milestone time of FIG. 16.

FIG. 18 is an internal configuration diagram of a management system for detailed engineering of a plant project according to an embodiment of the present disclosure.

FIG. 19 is a flowchart illustrating a process of performing assessment on a steel cutting schedule according to a management method for detailed engineering of a plant project according to an embodiment of the present disclosure.

FIG. 20 is a flowchart illustrating a process of performing assessment on a production start time in a block unit according to a management method for detailed engineering of a plant project according to an embodiment of the present disclosure.

FIG. 21 is an diagram showing a software configuration of a management system for detailed engineering of a plant project according to an embodiment of the present disclosure.

### DETAILED DESCRIPTION

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

Here, terminologies used herein are merely used to describe a specific embodiment, and are not intended to limit the present disclosure. A singular form used herein includes a plural form as long as phrases do not express a clearly opposite meaning. The term “include” used in the specification specifies specific characteristics, a specific area, a specific essence, a specific step, a specific operation, a specific element, and/or a specific ingredient, and does not exclude existence or addition of the other characteristics, the other area, the other essence, the other step, the other operation, the other element, and/or the other ingredient.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Hereinafter, embodiments of the present invention will be described in detail with reference to the accompanying drawings. The same or like reference numerals are used for the same components in the drawings.

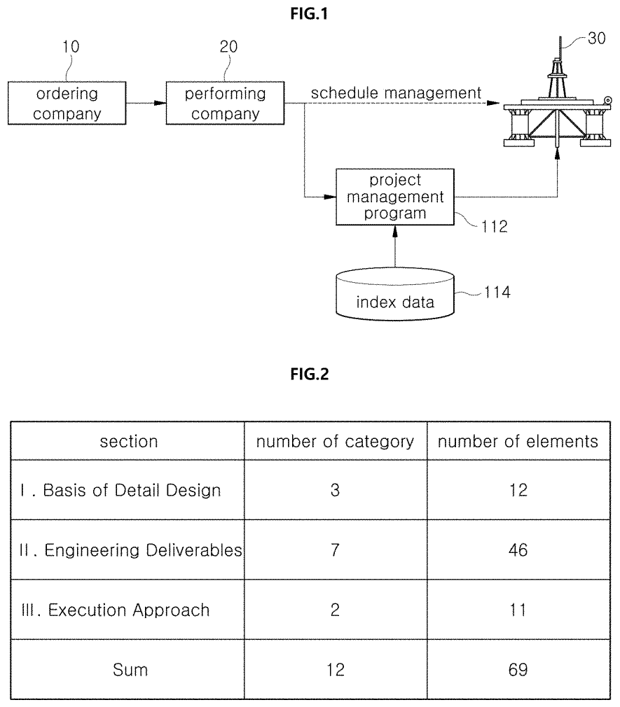

FIG. 1 is a conceptual diagram of a management method for detailed engineering of a plant project according to an embodiment of the present disclosure.

Referring to FIG. 1, according to the management method for detailed engineering of a plant project of the present disclosure, when a performing company 20 obtains an order of a plant 30 construction from an ordering company 10 and performs a project from engineering to construction, the performing company 20 selects index data including index elements required for measurement of completion of plant and efficiently manages a schedule of a plant project using the index data 114 in a project management program 112. Accordingly, the index data 114 and the project management program 112 may be managed and used in the performing company 20 which obtains the order of engineering and construction of the plant from the ordering company 10.

The index data 114 corresponds to a set of information selected as factors that may affect the whole process from engineering to construction of the plant based on various data related to the plant project. Details of the index data 114 and its contents will be described in detail below.

The project management program 112 forecasts a cost increase or process delay that may occur in the process of engineering and constructing the plant constructed by the performing company 20 based on the selected index data 114 and informs a plant project manager of the forecasted cost increase and process delay. Therefore, if a cost increase or process delay of the plant project is forecasted through the project management program 112, the management system for detailed engineering of a plant project according to the present disclosure displays corresponding information through a display for the manager to recognize it and modify a project schedule or process. A specific data process of the project management program 112 will be described in detail hereinbelow.

For management of detailed engineering of the plant project, an operation of establishing the index data 114 for measuring completion of the entire process from engineering to construction of the plant may be first performed.

To this end, the inventor of the present application collected candidate elements that may affect project completion from engineering to construction of the plant from various data regarding plant construction such as power plants, port docks, factories, and oil drilling ships. Representative data used to collect candidate elements are as follows.

Document Project Readiness by Estimate Class. AACE International Transactions. 2011.

Herve Baron. Oil & Gas Engineering Guide. Second Edition. Editions Technip. 2015.

Gibson, George E., Project Definition Rating Index (PDRI). Bureau of Engineering Research. University of Texas at Austin, 1996.

Bingham, Evan. Development of the project definition rating index (PDRI) for infrastructure projects. Arizona State University, 2010.

Wesley A. Collins. Development of the Project Definition Rating Index (PDRI) for Small Industrial Projects. Arizona State University, 2015.

About 98 candidate elements were extracted first based on the above data, and 69 index elements expected to directly affect the plant project were selected by referring to past plant construction cases and expert opinions in the plant field. Feasibility of the selected index elements may be applied to existing plant cases, whereby a statistical assessment of engineering maturity may be made. The 69 selected index elements include the index data 114 and are used for assessment of engineering maturity based on the project management program 112.

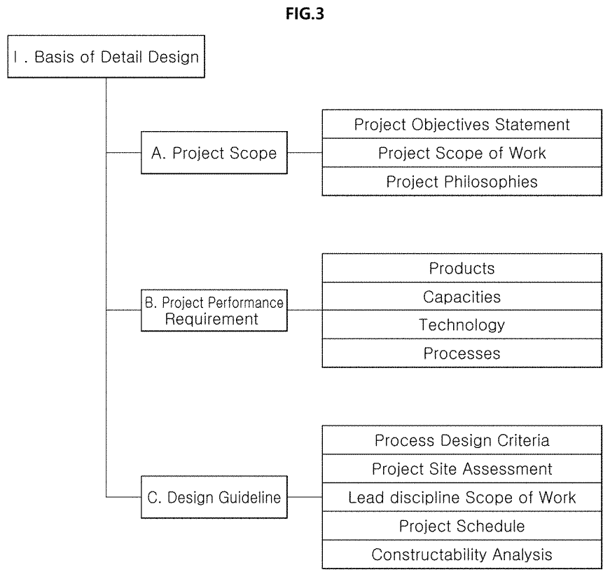

FIGS. 2 to 5 are views showing index elements selected for use in assessing engineering maturity of a plant project in a management method for detailed engineering of a plant project according to an embodiment of the present disclosure.

The 69 selected index elements may be divided into three sections in consideration of the process from engineering to construction of the plant, and categories may be divided each section may be divided in detail in each section.

In FIG. 2, three sections and subcategories of 69 index elements are shown. In FIGS. 3 to 5, subcategories and index elements belonging to each subcategory of each section are specifically shown.

The index elements used in the management method for a plant project of the present disclosure may be classified into a Basis of Detail Design section, Engineering Deliverables section, and Execution Approach section as shown in FIG. 2.

The Basis of Detail Design section may include index elements required for understanding an objective of the plant project. The completion of the Basis of Detail Design section serves to access whether the various organizations carrying out the plant project are organized for the objective of the project.

The Engineering Deliverables section includes index elements for the technical information required for understanding and accessing technical requirements for the project during a period of the Basis of Detail Design. For example, the Engineering Deliverables section may be configured to reflect a Preliminary issue that may reflect regulations related to Engineering Deliverables, opinions of the ordering company, a preliminary issue that may reflect work elements, Issue for Approval of the ordering company for sharing information between related documents, Approval for Design for finalizing design regulations reflecting the opinions of the ordering company, Approved for Construction for finalizing and completing the Basis of Detail Design for construction, and the like.

The Execution Approach section may include index elements required for understanding an approach required for carrying out the project until the plant is completed in line with a business direction of the ordering company.

In FIG. 3, index elements included in the Basis of Detail Design section are shown for each category.

The Basis of Detail Design section may be classified into three categories: Project Scope, Project Performance Requirement, and Design Guideline.

The Project scope may include index elements related to the scope of work to be performed in the project to meet the needs of the organization. The index elements constituting the Project Scope may include Project Objectives Statement, which indicates the objective of the project, Project Scope of Work which defines a scope of work and constraints of the project, and Process Philosophies which reflects values that the project seeks to pursue.

Project performance Requirement may include index elements for basic design strategies and requirements for project completion. The Project Performance Requirement may include products that correspond to a project output, Capabilities that correspond to design results, Technology applied to the project, and Process corresponding to the process from engineering to completion, as the index elements.

In Design Guideline, subcategories of the Basis of Detail Design may include index elements. The Design Guideline may include Process Design Criteria which represents codes and criteria that define engineering of the project, Project Site Assessment regarding various regulatory requirements related to the project, Lead Discipline Scope of Work regarding procurement required to carry out the project, and Project Schedule that reflects a schedule, as the index elements.

In FIG. 4, index elements included in the Engineering Deliverables section are displayed for each category.

The Engineering Deliverables section may be divided into seven categories of Process/Mechanical/Piping, Equipment Vendor, Structural and Architectural, Instrument and Electrical, and Material Take-Off, 3D modeling, and General Facility Requirement.

Process/Mechanical/Piping may include index elements regarding an ongoing process and mechanical design of the project. For example, the Process/Mechanical/Piping category may act as a key index element in the case of a plant of extracting oil or gas such as an oil drilling ship. The Process/Mechanical/Piping may include Process Flow Diagrams for determining plant operating conditions, Heat and Material Balances as specifications to be followed during a plant operation, Piping and Instrumentation Diagrams representing a specific plant operating flow, Process Safety Management for managing potential risks caused by a surrounding environment or humans, Utility Flow Diagrams that reflect supply conditions of utility according to consumer's demand and requirements, Process Datasheets that provides necessary information for the manufacture of equipment, Equipment Mechanical Datasheets stipulating process datasheets for a material supplier to manufacture, Specifications stipulating detailed specifications, Piping System Requirements written for purchase standardization of plumbing fixtures, Plot Plan indicating a specific location and layout of equipment, Project Equipment Lists for an equipment list used for the plant project, Line Lists for Pipes used in the plant, Tie-in Lists indicating Pipe Connections, Piping Stress Analysis reflecting pipe durability against heat or pressure, Piping Isometric Drawings corresponding to 3D design drawings of piping, Piping Specialty Items Lists, and Instrument Index corresponding to a list of facilities in the plant, as index elements.

Equipment Vendor may include Equipment Procurement Status which represents a process of a plant equipment supplier, In-line and Instrument Procurement Status including a process of a supplier supplying in-line and facility, Equipment General Arrangement Drawings related to layout of equipment, Process and Mechanical Documents related to a machine used in the process of the project, Electrical and Instrument Documents related to an electrical installation, Structural and Architectural Documents related to the structure and design of the project, and Equipment Utility Requirements determining a design of a supply unit according to a load of utility, as index elements.

Structural and Architectural may include Structural Specification which represents specifications of a plant structure, Structural Analysis describing the plant structure in terms of deflection and pressure, the Structural and Architectural Arrangement Drawing which represents the requirements for plant structures and walls, and Weight Control Report considering a load or gravity of equipment as index elements.

Instrument and Electrical may include Control Philosophy which represents requirements of a control system, Logic Diagram which specifically represents a control process and function, Cable Schedule which represents connection of electrical cables, Hook-up Diagram which specifically represents a connection wiring between a facility and an electrical device, Critical Electrical Item list as a list of special electrical products, Electrical Single Line Diagram which represents a detailed configuration of electrical distribution system, and Instrument and Electrical Specification corresponding to specifications of an electrical facility, as index elements.

Material Take-Off may include Piping MTO for purchasing plumbing materials, Structural and Architectural MTO for purchasing materials of a building, and Instrument and Electrical Bulk Item MTO which represents a quantity or specification of cables or junctions, as index elements.

3D modeling may include 3D Modeling Review for optimizing space use, 3D Modeling Input (Equipment/Piping) that numerically represents a process of equipment and piping, 3D Modeling Input (Structural) that quantifies a process of plant structure, 3D Modeling Input (Architectural) that quantifies a process regarding a building, and 3D Modeling Input (Instrument and Electrical) that quantifies a process of an electric installation, as index elements.

General Facility Requirement may include, as index elements, Preservation and Storage Requirements for storage and preservation of all equipment, Transportation Requirements for transport of materials or facilities, and Welding Procedure Specification which specifies specifications for welding operations.

In FIG. 5, the index elements included in the Execution Approach section are shown for each category.

The Execution Approach section may be divided into two categories: Engineering Project Management and Project Execution Plan.

Engineering Project Management may include, as index elements, Team Participants and Roles for project participants and roles, Engineering/Construction Methodology for engineering and construction procedures and management methods, Deliverables for Design and Constructions for the provision of materials such as equipment or specifications, Deliverables for Commissioning and Closeout regarding commissioning of the plant, Owner Approval Requirements regarding approval requirements of the ordering company, Interface Management regarding the transfer of technology to another contractor in connection with plant construction, Risk Analysis regarding major risks and countermeasures, and Identify Long Lead/Critical Equipment and Materials for major equipment or long-term processes.

Project Execution Plan may include, as index elements, Project Cost Estimate and Controls for construction periods and costs, Procurement Procedures and Plans for delivery of all equipment or materials, and Project Change Control for changes in project scope or construction.

The index elements described above, for example, may be changed in their names and contents to other names or contents that are the same or similar, and some index elements that are less relevant to the completion of the plant project may be omitted or a new index element that may affect the completion of the plant project may be added.

Based on the selected index elements as described above, engineering maturity assessment may be conducted on the entire process from engineering and construction of the plant project. Here, since the plant as a project target is not only diverse but also varies according to the objective of the plant, application technology, construction period and cost, internal facilities, and operation personnel, different index elements may be applied according to projects performed by the performing company and the influence of index elements on the plant project may vary. In view of this, the inventor of the present application divided the selected index elements into levels of various stages according to completion and assigned a weight to each index element.

For weight distribution, the inventor of the present application conducted an engineering maturity assessment on 69 selected index elements for a number of experts who have expertise in plant construction and normalized the assessment results such that assessment scores for the entire index elements range from a minimum of 70 to a maximum of 1,000.

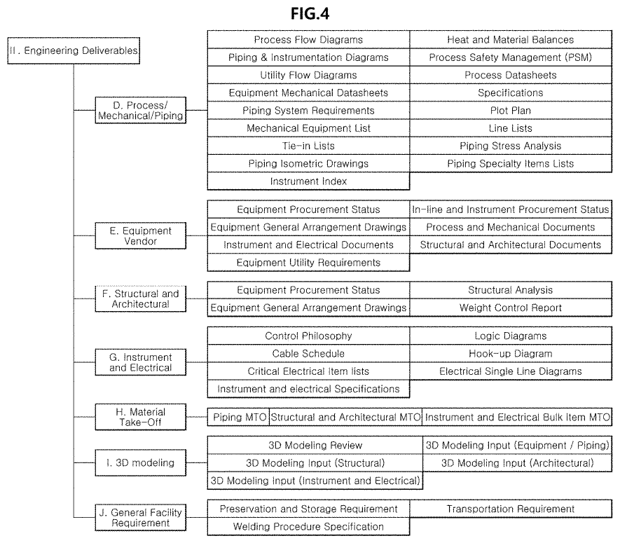

FIGS. 6(a) and 6(b) are diagrams each showing a weight distribution in a case where a weight is assigned to each index element in a management method for detailed engineering of a plant project according to the embodiment of the present disclosure.

Referring to FIG. 6(a), it can be seen that different weights are assigned to each section dividing the index elements and the sum of the weights of all three sections is 1,000.

In addition, referring to FIG. 6(b), it can be seen that, since different weights are assigned according to sub-items in the case of 12 subcategories of the entire sections, the weights are different for each category. Also, in this case, the sum of the weights for all 12 categories may be 1,000.

Some of these weights may be changed by reflecting characteristics of the index elements or the sum of the weights may be reset to a different value.

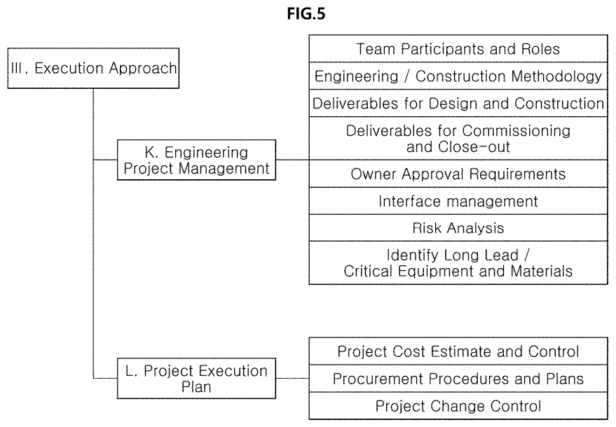

FIG. 7 is an diagram of an assessment sheet in which a weight is assigned to each index element belonging to a Basis of Detail Design section in a management method for detailed engineering of a plant project according to an embodiment of the present disclosure.

Referring to FIG. 7, the index elements for management for detailed engineering of the plant project according to the present disclosure may be divided into 5 levels. Among the entire levels 0 to 5, level 0 is not used for assessment for project management, and thus, the index elements used for engineering maturity assessment are classified into 5 levels from 1 to 5. Level 1 corresponds to a case where a corresponding index element is perfectly defined (Complete Definition), Level 2 refers to a case where a minor definition is missed (Minor Deficiencies), Level 3 refers to a case where some definitions are missed (Some Deficiencies), Level 4 refers to a case where a major definition is missed (Major Deficiencies), and Level 5 refers to a case where a corresponding index element is not properly defined (Incomplete or Poor Definition). Therefore, it can be evaluated that, as levels are lower, corresponding index elements are properly defined and closer to engineering maturity of the project.

Here, an example of a score card for the Basis of Detail Design section is illustrated. Referring to the Project Scope in the Basis of Detail Design section, it can be seen that Project Objectives Statement element has weights between 1 and 9, Project Scope of Work element has weights between 1 and 17, and the Process Philosophies element has weights between 1 and 13.

The inventor of the present application verified feasibility of selection and weighting of the index elements by conducting an engineering maturity assessment on an existing plant project constructed using the weighted index elements as described above.

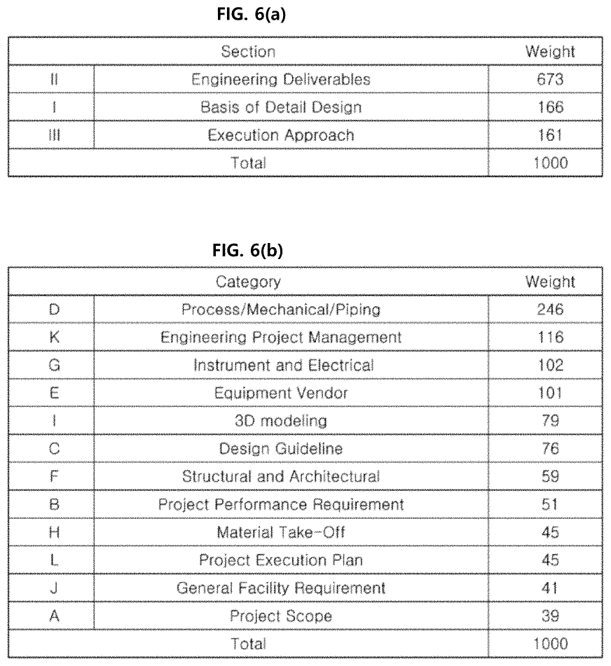

FIG. 8 is a diagram showing data of an existing case collected to verify feasibility of index data in a management method for detailed engineering of a plant project according to an embodiment of the present disclosure.

As shown in FIG. 8, data for 12 completed projects A to L and 1 ongoing project (X) for plant projects performed within the last 10 years are used to verify the feasibility of the index data. In particular, for ongoing project X, a method of forecasting performance by trend line analysis was applied. In the existing cases, project prices ranged between $500 million and $2 billion, with an average project duration of 42 months.

A time for starting construction of the entire plant project may be considered as a time of steel cutting, and in an intermediate process, a time for starting production of individual blocks constituting the plant may be considered as a time of starting individual work, and a time for handing over a completed plant to the ordering company may be considered as a time for terminating the project.

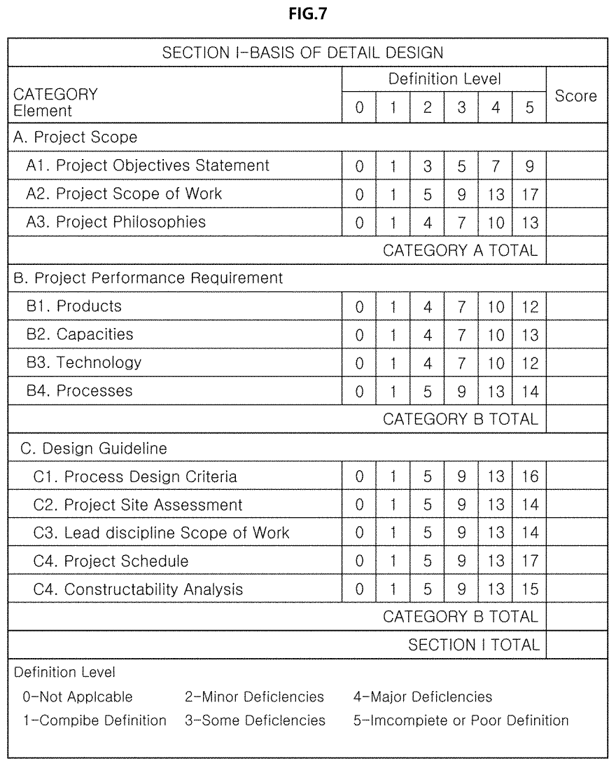

FIGS. 9(a) and 9(b) are diagrams showing results of performing an engineering maturity assessment of existing cases using a management method for detailed engineering of a plant project according to an embodiment of the present disclosure. FIG. 9(a) shows the DECRIS (Detailed engineering Completion Rating Index System) scores as engineering maturity assessment values of the existing cases and FIG. 9(b) shows the construction manhour increase rate (CMIR) And construction duration delay (CDD) that occurred in the existing cases.

Here, the construction labor hour increase rate (CLIR) is a value obtained by dividing a construction manhour increased due to a design change by a scheduled construction manhour, and the construction duration delay corresponds to a value obtained by subtracting the scheduled construction duration from an actual construction duration. Here, the construction duration delay may include all of problems of an error and omission of an engineer, a change request from the ordering company, a procurement impact, and a construction process, as well as the design change.

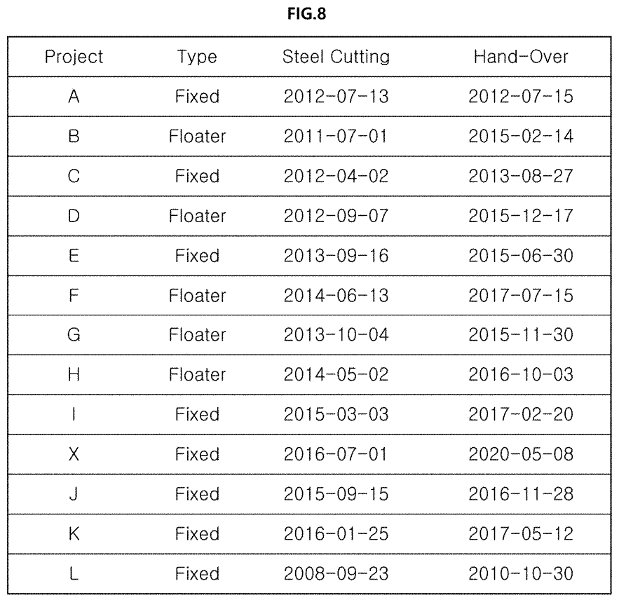

FIGS. 10(a), 10(b) and 10(c) are diagrams showing results of performing verification on a construction labor hour increase rate (CLIR) based on steel cutting corresponding to a start point of a plant project in a management method for detailed engineering of a plant project according to an embodiment of the present disclosure. As a verification method, an independent sample T test technique of analyzing whether mean values were sufficiently different between two different groups was used.

First, referring to FIG. 10(a), completion of 12 existing cases (A to L) may be divided into six cases (first group) having a DECRIS score greater than 300 and six cases (second group) having a DECRIS score smaller than 300.

The first group has a DECRIS score between 304 and 446, the CLIR ranges from 3.4 to 17.1%, and an average construction manhour increase rate (CMIR) is 7.7%. Meanwhile, the second group has a DECRIS score between 248 and 299, the CLIR ranges from 0.8 to 3.2%, and the average CMIR is merely 2.2%. FIG. 10(b) is a graph showing the average CMIRs of the first group and the second group. In addition, FIG. 10(c) shows T test results of assessing significance of the difference between the CLIRs of the first group and the second group based on the DECRIS score 300. As can be seen from the results, since the Pr>Itl value (0.0475) indicating significance is less than 0.05, it may can be considered that the CLIRs of the first group and the second group has a significant difference. Therefore, it may be determined that it is reasonable to use the DECRIS score 300 as a reference value in assessing the CLIR of the plant project.

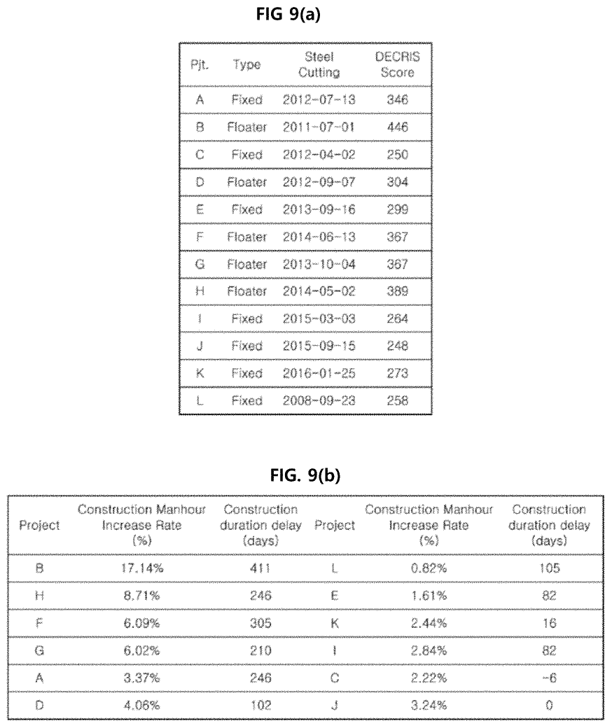

FIG. 11(a), 11(b) and 11(c) are diagrams showing results of performing verification on a construction duration delay (CDD) based on steel cutting corresponding to a start time of a plant project in a management method for detailed engineering of a plant project according to an embodiment of the present disclosure. Similarly, as the verification method, an independent sample T test technique of analyzing whether mean values are sufficiently different between two different groups was used.

First, referring to FIG. 11(a), when completion of 12 existing cases A to L is divided into six cases (first group) having a DECRIS score greater than 300 and six cases (second group) having a DECRIS smaller than 300, the first group has a DECRIS score between 304 and 446, the CDD has a distribution of 102 to 411 days, and an average CDD corresponds to 255 days. Meanwhile, the second group has a DECRIS score between 248 and 299, a CDD has a distribution from −6 days to 105 days, and an average CDD is merely 47 days. FIG. 11(b) is a table of the average CDDs of the first group and the second group. In addition, FIG. 11(c) is a T test result assessing the significance of the difference between the CDDs of the first group and the second group based on the DECRIS score 300. As can be seen from the results, since the Pr>Itl value (0.0012) indicating significance is less than 0.05, it may be said that the CDDs of the first group and the second group have a significant difference. Therefore, it may be determined that it is reasonable to use the DECRIS score 300 as a reference value in assessing the CDDs of plant projects.

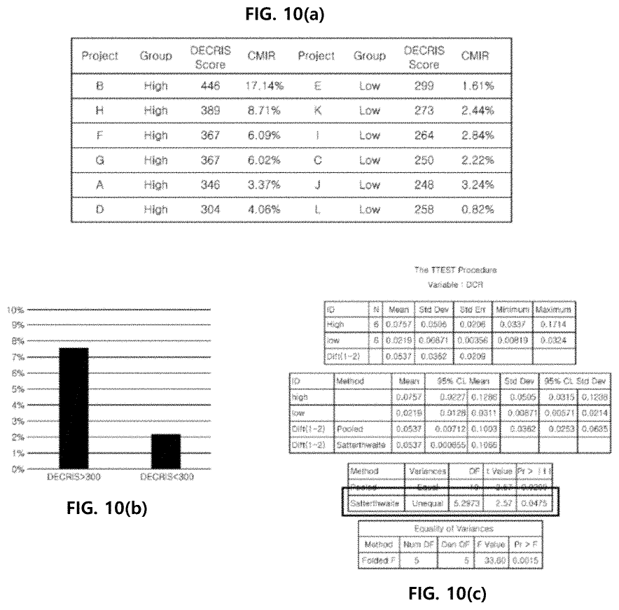

FIG. 12 is a graph illustrating a correlation between detailed engineering completion rating index system (DECRIS) scores as engineering maturity assessment results and construction manhour increase rates (CMIR) of existing cases, in a management method for detailed engineering of a plant project according to an embodiment of the present disclosure.

Referring to FIG. 12, a simple linear regression analysis using the DECRIS score as an X axis and the CLIR as a Y axis may yield a regression analysis function of y=0.0006x-0.1396 is obtained. In addition, since a coefficient of determination R squared value according to the regression analysis is 0.7393, it can be seen that the DECRIS score and the CLIR has a high correlation. That is, a possibility of an increase of a construction period of the plant project may be forecasted according to the engineering maturity assessment result based on the management method for a plant project of the present disclosure and an increase in construction cost may be forecasted in proportion to the CMIR.

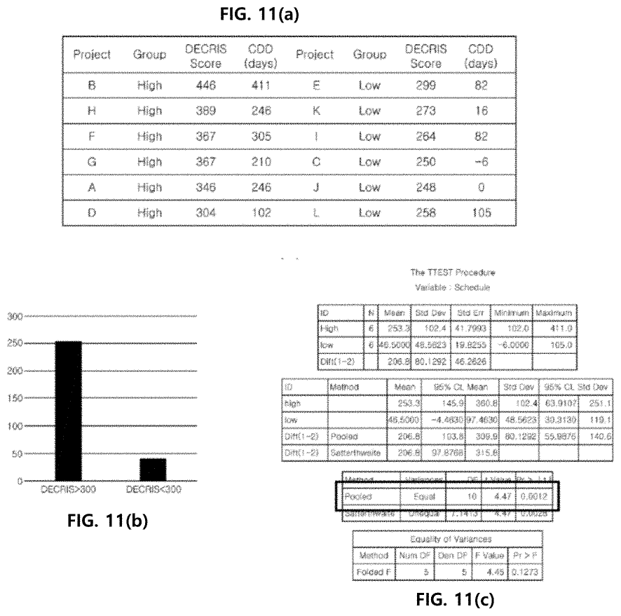

FIG. 13 is a diagram showing a correlation between DECRIS scores as engineering maturity assessment results and CDD of existing cases, in a management method for detailed engineering of a plant project according to an embodiment of the present disclosure.

Referring to FIG. 13, a simple linear regression analysis using the DECRIS score as the X axis and the CDD as the Y axis may yield a regression analysis function of y=2.0295x-511.22. In addition, since the coefficient of determination R squared value according to the regression analysis is 0.9305, it can be seen that the correlation between the DECRIS score and the CDD is very high. Therefore, referring to the engineering maturity assessment results based on the management method for the plant project of the present disclosure, the possibility of occurrence of construction delay may be forecasted according to the engineering maturity at a start time of the plant project.

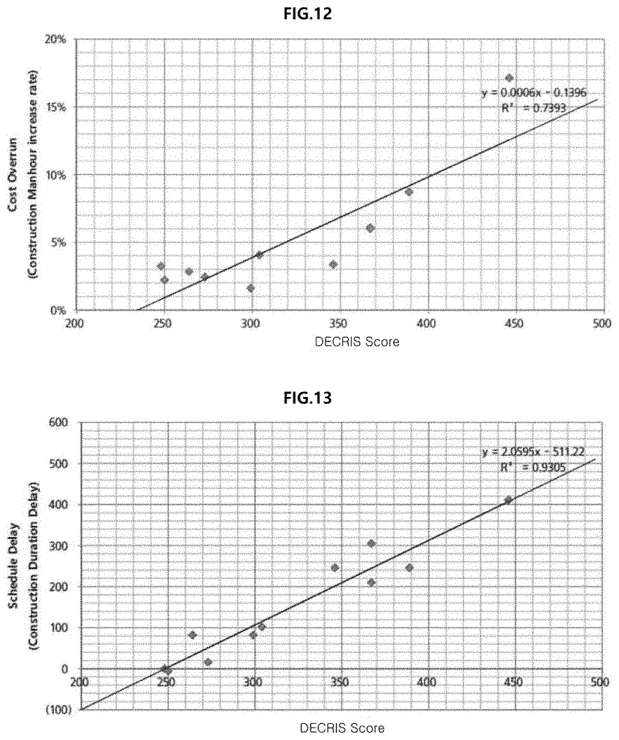

FIG. 14 is a table showing comparison between results of applying a management method for detailed engineering of a plant project according to an embodiment of the present disclosure to a currently ongoing plant project and forecasted process values at a corresponding time.

Referring to FIG. 14, results of performing the engineering maturity assessment based on the index elements defined in the management method for the plant project of the present disclosure regarding the currently ongoing plant project X show that the DECRIS score corresponds to 368. When the DECRIS score is applied to the regression analysis function y=0.0006x-0.1396 for the CLIR, a forecasted CLIR was accessed to be 8.12% which is checked to be different by about 0.14% from a process delay rate of 8.26% forecasted by the project manager based on the assessment time.

In addition, when the DECRIS score of 368 is applied to the regression analysis function y=2.0595x-511.22 for the CDD, a forecasted CDD is calculated as 246.7 days which is checked to be different by about 70 days from the CDD of 177 forecasted by the project manager based on the assessment time.

As such, when the project management method of the present disclosure is applied to the engineering and construction of the plant project, the CMIR and the CDD may be forecasted according to the engineering maturity at the start time of the plant project, based on which damage due to construction costs or delays may be prevented.

Next, a method of designating an optimal construction start time by measuring engineering maturity in five key milestones from a start time of construction to a start time of execution approach will be described.

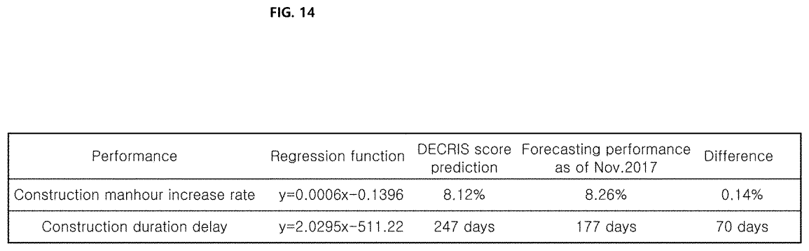

FIG. 15 is a graph showing DECRIS scores of reference based on a key milestone schedule according to an embodiment of the present disclosure.

The method of designating the start time of execution approach may include three steps.

The first step is to develop a DECRIS model. Here, a definition of a main schedule to perform assessment and a gate are included. A previous DECRIS model may be modified using FIS and AHP depending on a relative importance of each of the elements that affect project success. The resultant model may be accessed by calculating cutoff scores at each milestone using data from 14 historical projects. Details thereof has been described, and FIS and AHP will be described later.

The next step is to verify statistical significance using regression analysis and fsQCA. When estimating cost performance of the project against a schedule by comparing the aforementioned DECRIS and a commercial PDRI model, the regression analysis statistical significance of the modified DECRIS (AHP and FIS) may be compared to determine model validity. In addition, importance of each model is qualitatively compared using fsQCA.

Finally, case research for the project may be performed through several key schedules (i.e., research may be conducted to confirm and propose the use of front end engineering and design (FEED) verification model at a contract time). In FEED validation, DECRIS scores are assessed through review of invite to bid (ITB) documents and cost performance is estimated against schedule. A method of mitigating a risk of cost against schedule to assess trade-off cost may be proposed through a Monte Carlo simulation (MCS). Forecasted results for project performance may be compared with actual project cost overrun in the engineering and construction sectors.

Meanwhile, the method of designating an optimal execution approach start time is based on the DECRIS model described above.

AHP is a decision tool that determines a hierarchical structure and calculates a relative importance between individual sets of elements through pairwise comparison. The AHP method may be used for a variety of decision-making issues, including project management issues. A typical AHP process involves defining problems, determining a hierarchical structure, comparing pairs of each element, calculating relative weights, and identifying AHP results using a consistent ratio. The consistent ratio for verifying AHP follows [Equation 1].

C.R=consistency index/random-like matrix=((λₘₐₓ-n)/(n-1))/R.I. [Equation 1]

Here, when n=3, R.I.=0.38.

FIS is widely used as a decision support tool and process control and may be applied to fuzzy set theory. A fuzzy set function is a probability function and may represent a value from 0 to 1.

FsQCA may be an effective way to perform an analysis that includes both qualitative and quantitative factors. Instead of functions divided into 0 and 1, a fuzzy membership function is used for fsQCA. For continuous variables such as percentage values, a fuzzy set theory may be applied. Through comparative analysis using the fuzzy set theory, fsQCA may qualitatively compare fuzzy set variables that affect results. FsQCA results may be verified through consistency and application coverage.

A method of developing a DECRIS model using AHP and FIS will be described.

Key engineering milestones are identified through past projects. In the past projects, five common major schedules may be selected. The selected major schedules are listed in Table 1.

TABLE 1

| Gate No. | Definition | Alternative Definition | Milestone |
|---|---|---|---|
| 1 | FEED | Effective | Contract |
| | Verification | Date | Award(CA) |
| 2 | Equipment | 30% Modeling | CA + 6 months |
| | Procurement | Review | |
| 3 | AFD P&ID | 60% Modeling | CA + 9 months |
| | | Review | |
| 4 | AFC P&ID | 90% Modeling | CA + 12 months |
| | | Review | |
| 5 | Steel Cutting | Work Order | CA + 15 months |

DECRIS cutoff scores of the key engineering milestones may be determined as shown in Table 2 through 10 independent sets of tests.

TABLE 2

| | FEED | Equipment | AFD | AFC | Steel |
|---|---|---|---|---|---|
| | Verification | Procurement | P&ID | P&ID | Cutting |
| Maximum | 872 | 725 | 574 | 490 | 416 |
| Mean | 813 | 659 | 503 | 395 | 308 |
| Minimum | 785 | 628 | 431 | 312 | 234 |
| Cutoff score | 810 | 660 | 500 | 380 | 300 |
| Upper limit | 849 | 702 | 555 | 482 | 389 |
| Lower Limit | 778 | 617 | 451 | 307 | 227 |

Regression analysis was performed to obtain 10 regression functions, which may be statistically verified as to whether all the regression functions and independent tests are allowed in terms of cost and schedule performance. A DECRIS cutoff score for assessing five detailed engineering steps from a contract to a time for steel cutting may be set, which may be statistically verified. FIG. 15 shows DECRIS thresholds (cutoff scores) and upper/lower limits of each major key engineering milestone for designating a DECRIS score.

The DECRIS cutoff score represents a criteria by which engineering maturity is achieved in five key engineering process steps. The construction risk is reduced when the DECRIS cutoff score is achieved for each milestone. An EPC contractor may forecast construction results and mitigate risks using recovery strategies such as increasing manhours of design/engineering.

Hereinafter, a FEED Verification time will be referred to as a contract time, Equipment Procurement will be referred to as a first key milestone time, an AFD P&ID time will be referred to as a second key milestone time, an AFC P&ID time will be referred to as a third key milestone time, and a steel cutting time will be referred to as an estimated still cutting time.

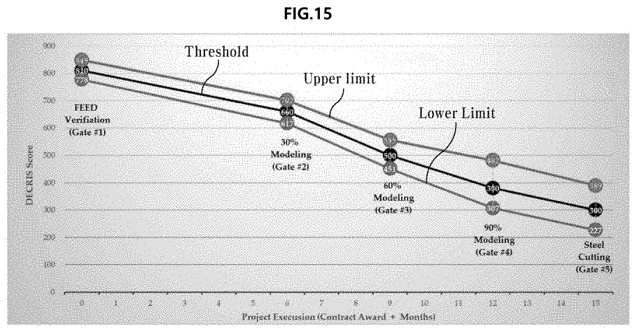

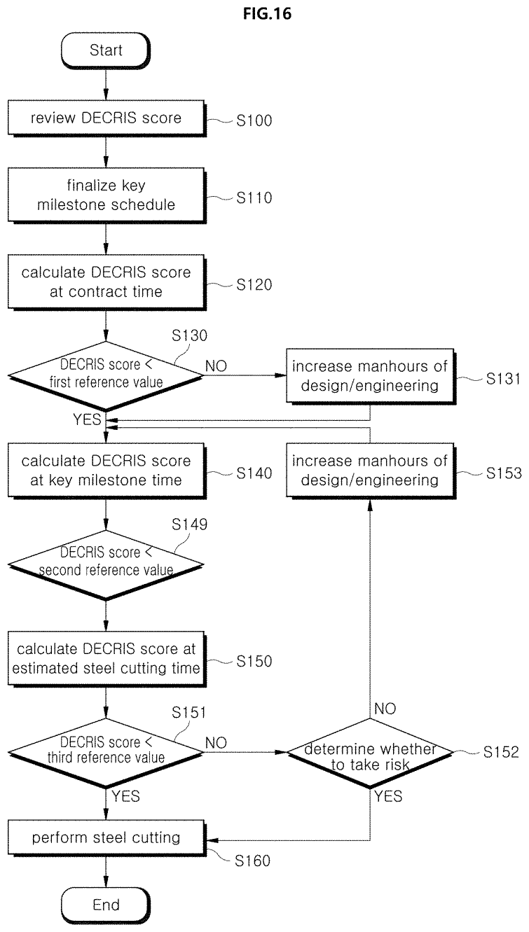

FIG. 16 is an algorithm flowchart illustrating a method of designating a start time of execution approach according to an embodiment. FIG. 17 is a flowchart specifically illustrating steps of calculating a score and using a recovery strategy at a key milestone time of FIG. 16.

Referring to FIGS. 16 and 17, a method of designating a start point of execution approach by a system may include a step (S100) of reviewing DECRIS score, a step (S110) of finalizing a key milestone schedule, a step (S120) of calculating DECRIS score at a contract time, a step (S141) of calculating a DECRIS score at a first key milestone time, a step (S144) of calculating a DECRIS score at a second key milestone time, a step (S147) of calculating a DECRIS score at a third key milestone time, and a step (S150) of calculating a DECRIS score at an estimated steel cutting time.

In this disclosure, each step is described as being performed in turn according to a flowchart, but unless the spirit of the invention is changed, it is evident that the order of each step may be changed, some steps may be omitted, or another step may be further included between the steps. Hereinafter, the key milestone time may be used to include all of the first key milestone time, the second key milestone time, and the third key milestone time.

First, the system may perform a preparation step for reviewing a DECRIS score and finalizing a key milestone schedule.

In the step (S100) of reviewing a DECRIS, as described in Table 2 above a DECRIS cutoff score may be prepared. In an embodiment, the step (S100) of reviewing a DECRIS score may correspond to the step of preparing the engineering maturity assessment data including the index data described above.

In the step (S110) of finalizing a key milestone schedule, for example, the schedule may be finalized to a contract time, 6 months after the contract time, 9 months after the contract time, 12 months after the contract time, 15 months after the contract time according to [Table 1] above. Here, 15 months after the contract time may be an estimated steel cutting time. That is, the first key milestone time may be 6 months after the contract time, the second key milestone time may be 9 months after the contract time, and the third key milestone time may be 15 months after the contract time.

Next, the step (S120) of calculating a DECRIS score at the contract time may be performed, and a step (S130) of comparing the calculated DECRIS score with a first reference value may be performed.

In an embodiment, the first reference value may be 810 points. If the calculated DECRIS score is lower than the first reference value, the process is performed as planned, and if the calculated DECRIS score is higher than the first reference value, a recovery strategy may be used. For example, the recovery strategy may be achieved through a step (S131) of increasing manhours of design/engineering (S131). For example, the increase in manhours of design/engineering may be an increase in input manpower or an increase in manpower input time. After the step (S131) of increasing manhours of design/engineering, a next step may be performed.

However, the present disclosure is not limited thereto, and in some embodiments, a next schedule may be performed, while taking risks, although the calculated DECRIS score is higher than the first reference value. In addition, the next step may not be immediately performed after the step (S131) of increasing the manhours of design/engineering, and the DECRIS score may be calculated (e.g., S120 is performed) again and whether to perform the next step may then be determined.

Next, a step (S140) of calculating a DECRIS score at the key milestone time may be performed, and a step (S149) of comparing the calculated DECRIS score with a second reference value may be performed. Here, the key milestone time may be classified into several times as described above. Therefore, the step of calculating a DECRIS score for each milestone time and comparing the calculated DECRIS score with a predetermined individual reference value may be performed separately.

As an example, a step of calculating DECRIS scores at three key milestone times and comparing the calculated DECRIS scores with a reference value will be described in detail with reference to FIG. 17.

First, a step (S141) of calculating a DECRIS score at the first key milestone time may be performed, and a step (S142) of comparing the calculated DECRIS score with a fourth reference value may be performed.

In an embodiment, the fourth reference value may be 660 points. If the calculated DECRIS score is lower than the fourth reference value, the process may be performed as planned, and if the calculated DECRIS score is higher than the fourth reference value, a recovery strategy may be used. As a recovery strategy, after a step (S143) of increasing manhours of design/engineering, a next step may be performed.

However, the present disclosure is not limited thereto, and in some embodiments, a next schedule may be performed, while taking risks, although the calculated DECRIS score is higher than the fourth reference value. In addition, the next step may not be immediately performed after the step (S143) of increasing the manhours of design/engineering, and the DECRIS score may be calculated (e.g., S141 is performed) again and whether to perform the next step may then be determined.

Next, a step (S144) of calculating a DECRIS score at a second milestone time may be performed, and a step (S145) of comparing the calculated DECRIS score with a fifth reference value may be performed.

In an embodiment, the fifth reference value may be 500 points. If the calculated DECRIS score is lower than the fifth reference value, the process may be performed as planned, and if the calculated DECRIS score is higher than the fifth reference value, a recovery strategy may be used. As a recovery strategy, after a step (S146) of increasing the manhours of design/engineering, the next step may performed.

However, the present disclosure is not limited thereto, and in some embodiments, a next schedule may be performed, while taking risks, although the calculated DECRIS score is higher than the fifth reference value. In addition, the next step may not be immediately performed after the step (S146) of increasing the manhours of design/engineering, and the DECRIS score may be calculated (e.g., S144 is performed) again and whether to perform the next step may then be determined.

Next, a step (S147) of calculating a DECRIS score at the third key milestone time may be performed, and a step (S148) of comparing the calculated DECRIS score with a sixth reference value may be performed.

In an embodiment, the sixth reference value may be 380 points. If the calculated DECRIS score is lower than the sixth reference value, the process may be performed as planned, and if the calculated DECRIS score is higher than the sixth reference value, a recovery strategy may be used. As the recovery strategy, after the step (S149) of increasing the manhours of design/engineering, the next step may be performed.

However, the present disclosure is not limited thereto, and in some embodiments, a next schedule may be performed, while taking risks, although the calculated DECRIS score is higher than the sixth reference value. In addition, the next step may not be immediately performed after the step (S149) of increasing the manhours of design/engineering, and the DECRIS score may be calculated (e.g., S147 is performed) again and whether to perform the next step may then be determined.

Next, a step (S150) of calculating a DECRIS score at the estimated steel cutting time may be performed, and a step (S151) of comparing the calculated DECRIS score with the third reference value may be performed.

In an embodiment, the third reference value may be 300 points. If the calculated DECRIS score is lower than the third reference value, the steel cutting may be performed (S160), and if the calculated DECRIS score is higher than the third reference value, a step (S152) of determining whether to perform steel cutting, while taking the risk of execution approach may be further performed.

In the step (S152) of determining whether to perform steel cutting, while taking the risk of execution approach, the steel cutting may be performed (S160) if it is determined that the risk of execution approach is taken. Also, if it is determined that the risk of execution approach is not taken, the recovery strategy may be used. After increasing the manhours of design/engineering (S153), the DECRIS score may be calculated, and whether to perform steel cutting may be determined again (S160). In addition, while increasing the manhours of design/engineering (S153), a step (S153-1) of delaying the steel cutting may be performed together.

Hereinafter, a management system for detailed engineering of a plant project will be described.

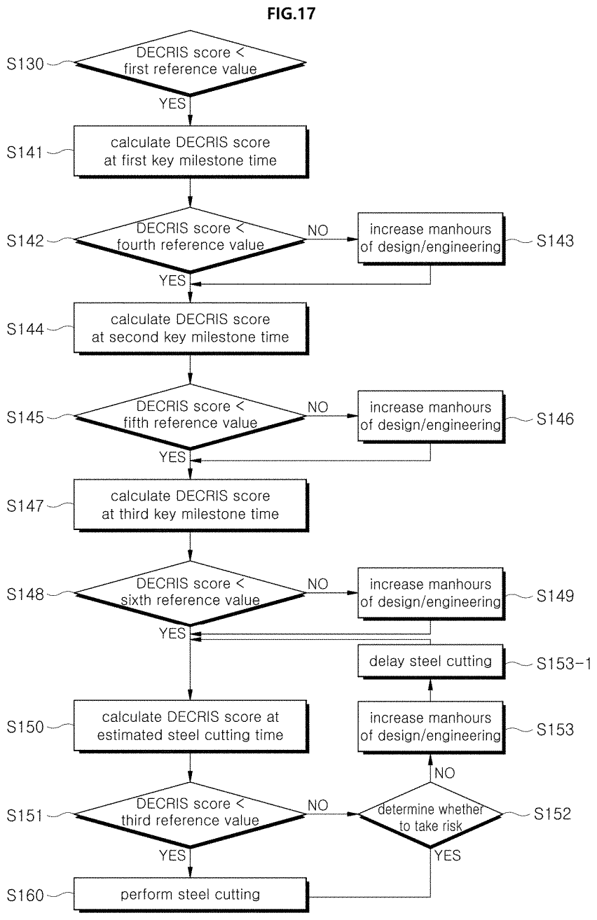

FIG. 18 is an internal configuration diagram of a management system for detailed engineering of a plant project according to an embodiment of the present disclosure.

Referring to FIG. 18, a management system 100 for detailed engineering of a plant project according to the present disclosure may include a database (DB) 110, at least one controller 120 connected to the DB 110 and performing a high-speed operation, an input device 130, and an output device, and an output device 140.

The DB 110 may store the project management program 112 and the index data 114 including the index elements that may affect the process of the plant project according to the present disclosure. Here, the DB 110, in which the project management program 112 and the index data 114 are stored, may be generally a high speed main memory as a storage medium such as a random access memory (RAM) and a read only memory (ROM), an auxiliary memory such as a flash memory or the like, and a device storing data using an electrical, magnetic, optical, or other storage medium. It will be apparent to those skilled in the art that the DB 110 is a product having various storage capabilities and may have various forms.

The project management program 112 according to the present disclosure may correspond to one application program configuring the management system 100 for detailed engineering of a plant project. Therefore, the management system 100 for detailed engineering of a plant project of the present disclosure may include an operating system (OS) and at least one application program. The OS is a software set that controls the operation of the management system 100 for detailed engineering of a plant project and designation of resources. The application program, as a software set for performing work requested by the user by using an available computer resource through the OS, may include the project management program 112 and other application programs. The OS and application programs may reside in the DB 110. In accordance with the experience of those skilled in the art of computer programming, the present disclosure will be described according to an operation performed by the management system 100 for detailed engineering of a plant project and representation symbols for the operation, unless otherwise stated. The operation is computer-based and may be performed by the OS or an appropriate application program. In addition, the operation and function may include processing on an electrical signal such as a data bit or the like, causing conversion or interruption of the electric signal, changing an operation of the management system 100 for detailed engineering of a plant project, and managing a bit signal stored in a memory region of the DB 110. The memory region in which the data bit signal is managed may be a physical region having electrical, magnetic or optical characteristics corresponding to a data bit.

The input device 130 may be a device capable of recognizing a user's operation or touch, such as a mouse, a keyboard, or a touch screen, but may also include a physical transducer such as a microphone. When a CMIR or a CDD of a plant project is to be forecasted by the project management program 112 of the present disclosure assessment scores of the index elements described on an assessment sheet including the index data 114 may be input to the management system 100 for detailed engineering of a plant project through the input device 130. The assessment scores of the index elements input through the input device 130 may be calculated and assessed by the project management program 112, in a state of being stored in a main memory or an auxiliary memory of the DB 110 temporarily or for a long term.

The output device 140 refers to a display capable of displaying characters or images, such as a light emitting diode (LED), a liquid crystal display (LCD), or an electronic ink (e-ink), but may also include a transducer such as a speaker. When the project management program 112 assesses the CMIR or the CDD, a corresponding result may be displayed on a screen through the output device 140.

The controller 120 is embedded in the management system 100 for detailed engineering of a plant project and performs a function of processing the overall operation. That is, in order to forecast the CMIR or the CDD based on engineering maturity of the plant project, the controller 120 controls the operation of the project management program 112 using the index data 114 in the DB 110. The controller 120 may include an arithmetic logic unit (ALU) 122 performing calculation, a register 124 temporarily storing data and instructions, and a controller 126 controlling the operation of the management system 100 for detailed engineering of a plant project.

The controller 120 may be a control processor (CPU) processor having various architectures such as Alpha of DIGITAL, MIPS of MIPS Technology, NEC, IDT, Siemens, etc., x86 of companies including Intel, Cyrix, A M D, and Nexgen, and power PC of IBM and Motorola.

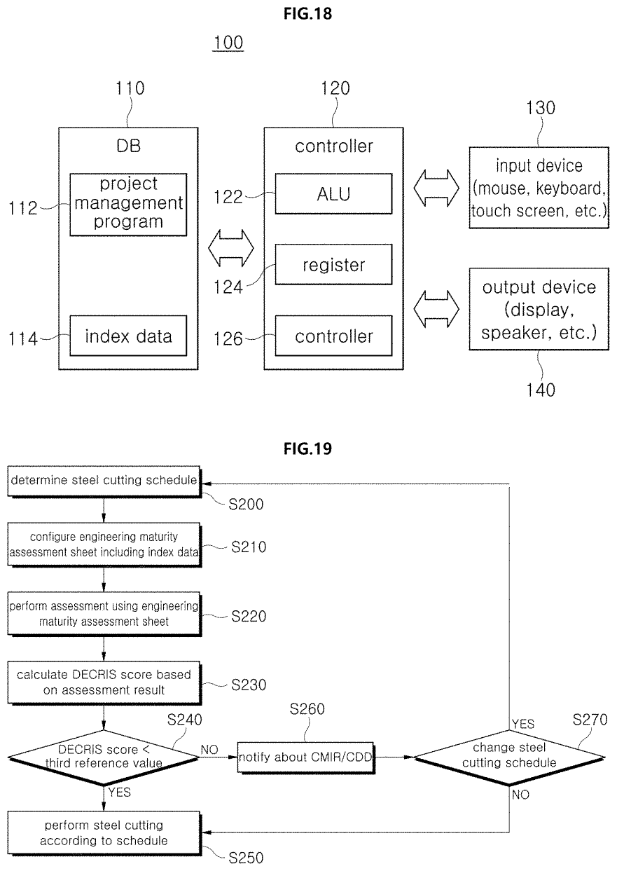

FIG. 19 is a flowchart illustrating a process of performing assessment on a steel cutting schedule according to a management method for detailed engineering of a plant project according to an embodiment of the present disclosure. FIG. 19 specifically shows the step of calculating a DBCRIS score at an estimated steel cutting time and comparing the DBCRIS score with a third reference value.

Since steel cutting may be considered as a time for starting execution approach of the entire plant project, appropriately determining a steel cutting schedule such that a construction period is not increased or construction delay does not occur may act as an important starting point of the plant project.

Referring to FIG. 19, a management method for detailed engineering of a plant project according to the present disclosure may include determining a steel cutting schedule (S200), configuring an engineering maturity assessment sheet including index data (S210), performing assessment using the engineering maturity assessment sheet (S220), calculating an engineering maturity assessment value (DECRIS score) based on the assessment result (S230), comparing the DECRIS score with a reference value (S240), performing steel cutting according to a schedule if the DECRIS score is less than the reference value (S250), notifying about a CMIR or a CDD if the DECRIS score is greater than the reference value (S260), and determining whether to change the steel cutting schedule (S270).

The determining of the steel cutting schedule (S200) may be a step of predetermining the steel cutting schedule starting the project in consideration of the overall schedule of the plant project. The steel cutting schedule determined in this step may be determined in consideration of a project performance ability of the performing company and a time for handing over the plant facility to the ordering company.

The configuring of the engineering maturity assessment sheet including the index data (S210) may be a step of finalizing the assessment sheet reflecting levels and weights for predetermined index elements for engineering maturity assessment of the plant project. As the index elements, all 69 items described above may be used or elements that may directly affect the determination of the steel cutting schedule may be selectively used.

The performing of assessment using the engineering maturity assessment sheet (S220) may be a step of determining an assessment value for each index element to be accessed using the assessment sheet. Assessment values made by experts in the plant project field may be provided to the management system 100 for detailed engineering of a plant project by the input device 130.

The calculating of the engineering maturity assessment value (DECRIS score) based on the assessment result (S230) may be a step of calculating the DECRIS score by adding up all the assessment values of the index elements for which the assessment has been made. The DECRIS score may vary depending on the weight and the number of index elements. As described above, the sum of the assessment scores for all the index elements may be set to be a minimum of 70 to a maximum of 1,000.

The comparing of the DECRIS score with the reference value (S240) may be a step of comparing the DECRIS score calculated above with the reference value for determining whether to change the steel cutting schedule. If the sum of the assessment scores for all 69 index elements is set to be from 70 to 1,000, the reference value may be 300.

The performing of steel cutting according to the schedule if the DECRIS score is less than the reference value (S250) may be a step of performing steel cutting according to the determined schedule by determining that engineering and execution approach plan of the plant project are appropriately made.

The notifying about the CMIR or the CDD if the DECRIS score is greater than the reference value (S260) may be a step of determining that there is a high possibility of an increase in the construction period of the plant project or the occurrence of construction delay in the case of the current engineering or execution approach plan and notifying the project manager accordingly.

The determining of whether to change the steel cutting schedule (S270) may be a step of determining whether to change the steel cutting schedule with reference to the assessment result by the management system 100 for detailed engineering of a plant project of the present disclosure. If the steel cutting schedule is determined to be changed, the plant project may be performed according to the changed schedule, or if not, the plant project may be performed according to the existing schedule.

The management method for detailed engineering of a plant project may be used for assessing and managing the overall project schedule or may also be used for assessing and managing a schedule for a plurality of block unit processes configuring the project.

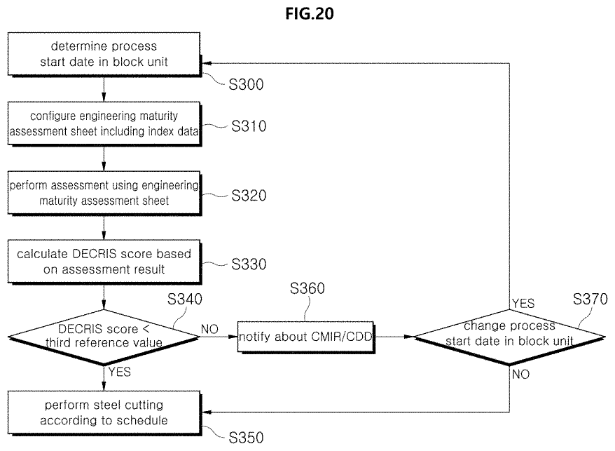

FIG. 20 is a flowchart illustrating a process of performing assessment on a production start time in a block unit according to a management method for detailed engineering of a plant project according to an embodiment of the present disclosure.

Referring to FIG. 20, the management method for detailed engineering of a plant project according to the present disclosure may include determining a process start date in block units (S300), configuring an engineering maturity assessment sheet including index data (S310), performing assessment using the engineering maturity assessment sheet (S320), calculating an engineering maturity assessment value (DECRIS score) based on the assessment result (S330), comparing the DECRIS score with a reference value (S340), performing a process in block units according to a schedule if the DECRIS score is less than the reference value (S350), notifying about a CMIR or a CDD if the DECRIS score is greater than the reference value (S360), and determining whether to change the process start date in block units (S270).

The determining of the process start date in block units (S300) may be a step of individually determining a process start date in block units for subblock units configuring a plant project. The process start date in block units determined in this step is determined in consideration of a project performance ability of the performing company and a time for handing over the plant facility to the ordering company and the process.

The configuring of the engineering maturity assessment sheet including the index data (S310) may be a step of finalizing the assessment sheet reflecting levels and weights for predetermined index elements for engineering maturity assessment of the plant project. As the index elements, all 69 items described above may be used or elements that may directly affect the process in block units in consideration of the process characteristics in block units.

The performing of assessment using the engineering maturity assessment sheet (S320) may be a step of determining an assessment value for each index element to be accessed using the assessment sheet. Assessment values made by experts in the plant project field may be provided to the management system 100 for detailed engineering of a plant project by the input device 130.

The calculating of the engineering maturity assessment value (DECRIS score) based on the assessment result (S330) may be a step of calculating the DECRIS score by adding up all the assessment values of the index elements for which the assessment has been made. The DECRIS score may vary depending on the weight and the number of index elements. As described above, the sum of the assessment scores for all the index elements may be set to be a minimum of 70 to a maximum of 1,000.

The comparing of the DECRIS score with the reference value (S340) may be a step of comparing the DECRIS score calculated above with the reference value for determining whether to change the process schedule in block units. If the sum of the assessment scores for all 69 index elements is set to be from 70 to 1,000, the reference value may be 300. However, the reference value may be changed according the process characteristics in block units.

The performing of the process in block units according to the schedule if the DECRIS score is less than the reference value (S350) may be a step of performing the process according to the determined schedule by determining that engineering and execution approach plan for the process in block units are appropriately made.

The notifying about the CMIR or the CDD if the DECRIS score is greater than the reference value (S360) may be a step of determining that there is a high possibility of an increase in the construction period of the plant project or the occurrence of construction delay in the case of the current engineering or execution approach plan regarding the process in block units and notifying the project manager accordingly.

The determining of whether to change the process start date in block units (S370) may be a step of determining whether to change the process schedule in block units with reference to the assessment result by the management system 100 for detailed engineering of a plant project of the present disclosure. If the process start date in block units is determined to be changed, the process in block units may be individually performed according to the changed schedule, or if not, the process in block units may be performed according to the existing schedule.

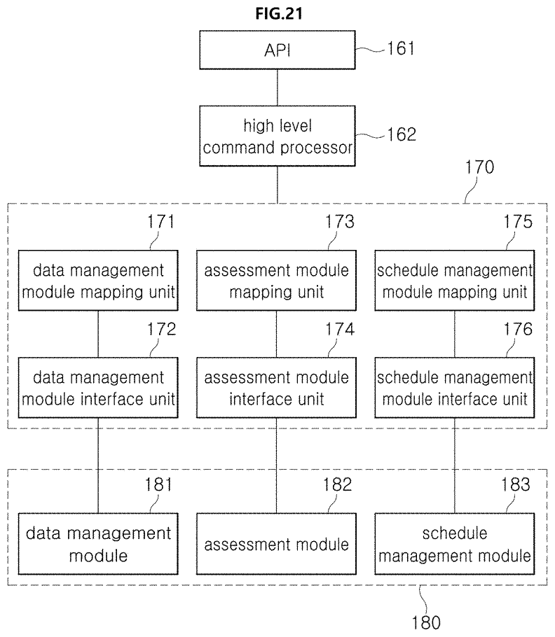

FIG. 21 is an diagram showing a software configuration of a management system for detailed engineering of a plant project according to an embodiment of the present disclosure.

Referring to FIG. 21, in the management system 100 for detailed engineering of a plant project of the present disclosure, an application module 180 may include a data management module 181 managing index data for assessing engineering maturity for a plant project, an assessment module 182 assessing engineering maturity of the plant project based on the index data and managing the result, and a schedule management module changing or managing steel cutting or a production start time in block units according to the assessment result.

Software including the application module 180 may use various OS as an OS of the system. The OS controls the operation of each application module 180 by providing a high level command to an application program interface (API) 161. The software installed in the management system 100 for detailed engineering of a plant project identifies each corresponding application module 180 according to the high level command provided from the API 161, decodes the high level command, and provides the decoded instruction to a corresponding place. The application module controller 170 controls the operation of the application module 180 according to the instruction provided from the high level command processor 162. That is, the high level command processor 162 identifies whether there is an application module 180 corresponding to the high level command provided through the API 161, and when the corresponding application module 180 exists, the high level command processor 162 decodes the high level command to a command that can be recognized by the corresponding application module 180 and transmits the decoded command to a corresponding mapping unit or controls message transmission. Accordingly, the application module controller 170 may include the mapping units 171, 173, and 175 and the interface units 172, 174, and 176 for the data management module 181, the assessment module 182, and the schedule management module 183.

The data management module mapping unit 171 receives the high level command for managing index data used for assessing engineering maturity of the plant project from the high level command processor 162, maps the high level command to a device level that can be processed by the data management module 181, and provides the same to the data management module 181 through the data management module interface unit 172.

The assessment module mapping unit 173 and the assessment module interface unit 174 receive the high level command for assessing engineering maturity of the project from the high level command processor 162, map the received high level command to a device level command, and provide the same to the assessment module 182 trough the assessment module interface unit 174.

The schedule management module 183 serves to notify and manage to change or maintain steel cutting or the process start date in block units according to the result of engineering maturity assessment of the plant project. The schedule management module mapping unit 175 receives the high level command applied through the high level command processor 162 and maps the high level command to the device level command that can be recognized by the schedule management module 183. The device level command is provided to the schedule management module 183 through the schedule management module interface 176.

Detailed member functions for the API 161 configured to perform these functions may include, for example, Open API, Close API, Retrieve API, Status API, Initialize API, List API, Register API (Unregister API), and Unregister API. Accordingly, such individual API 161 is executed according to an application module in use or a message transmission type, and accordingly, an application module capable of assessing engineering maturity of the plant project based on the index data and managing steel cutting or the process start date in block units by reflecting the assessment result may be used.

So far, the embodiments of the method and system for detailed engineering for a plant project according to the present disclosure have been described. The present disclosure is not limited to the embodiments described above and the accompanying drawings, and various modifications and variations may be made in view of those skilled in the art to which the present disclosure pertains. Therefore, the scope of the present disclosure should be defined not only by the claims of the present specification but also by the equivalents of the claims.

According to the embodiments of the present disclosure, it is possible to minimize the risk that may occur in the process of performing the project by forecasting the cost loss or duration delay caused by the increase in the manufacturing time during the process of the plant project.

In addition, outcomes based on construction costs and schedule may be forecasted continuously and the risks that may occur may be minimized by assessing the balance between resource and cost/schedule risk mitigation.

The effects according to the embodiments of the present disclosure are not limited by the contents exemplified above, and more various effects are included in the present disclosure.

The foregoing embodiments and advantages are merely exemplary and are not to be considered as limiting the present disclosure. The present teachings may be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

1. A management method for detailed engineering of a plant project in a method of managing a project in a system for managing a schedule of the plant project using index data required for measurement of completion rating of a plant after a contract time of the plant project, the management method comprising:
determining a start date for a process of the project;
preparing an engineering maturity assessment data including the index data;
determining a key milestone schedule including a key milestone time;
calculating a first engineering maturity assessment score at the contract time;
comparing the first engineering maturity assessment score with a first reference value,
calculating a second engineering maturity assessment score at the key milestone time;
comparing the second engineering maturity assessment score with a second reference value;
calculating a third engineering maturity assessment score at the start date; and
comparing the third engineering maturity assessment score with a third reference value,
wherein the process is performed according to the start date for the process of the project if the third engineering maturity assessment score is less than the third reference value.

2. The management method of claim 1, wherein the key milestone time comprises a first key milestone time six months after the contract time, a second key milestone time nine months after the contract time, and a third key milestone time 12 months after the contract time.

3. The management method of claim 2, wherein
the calculating of the second engineering maturity assessment score at the key milestone time and the comparing of the second engineering maturity assessment score with the second reference value comprise:
calculating a fourth engineering maturity assessment score at the first key milestone time;
comparing the fourth engineering maturity assessment score with a fourth reference value;
calculating a fifth engineering maturity assessment score at the second key milestone time;
comparing the fifth engineering maturity assessment score with a fifth reference value;
calculating a sixth engineering maturity assessment score at the third key milestone time; and
comparing the sixth engineering maturity assessment score with a sixth reference value.

4. The management method of claim 3, wherein
the first reference value is 810, the fourth reference value is 660, the fifth reference value is 500, and the sixth reference value is 380.

5. The management method of claim 3, further comprising:
increasing a design man-hour after at least one of the steps of comparing the first engineering maturity assessment score with the first reference value, comparing the second engineering maturity assessment score with the second reference value, comparing the third engineering maturity assessment score with the third reference value, comparing the fourth engineering maturity assessment score with the fourth reference value, comparing the fifth engineering maturity assessment score with the fifth reference value, and comparing the sixth engineering maturity assessment score with the sixth reference value.

6. The management method of claim 1, wherein
the first, second and third reference values are calculated based on data including a basis of detail design section, an engineering deliverables section, and an execution approach section.

7. The management method of claim 6, wherein
the basis of detail design section comprises a category of a project scope, a project performance requirement, and a design guideline.

8. The management method of claim 6, wherein
the engineering deliverables section comprises process/mechanical/piping, equipment vendor, structural and architectural, instrument and electrical, material take-off, 3D modeling, and general facility requirement category.

9. The management method of claim 6, wherein
the execution approach section comprises an engineering project management and project execution plan category.

10. The management method of claim 7, wherein
the category comprises each of a plurality of index elements reflecting characteristics of the category, the plurality of index elements are divided into a plurality of stages different in level, and each level may be given a weight according to the plurality of index elements.

11. The management method of claim 10, wherein
the weight is normalized such that an assessment score for all of the plurality of index elements is a maximum of 1,000.

12. The management method of claim 11, wherein
the third reference value is 300 points.

13. The management method of claim 1, further comprising:
increasing design man-hour such as increasing manpower input time.

14. A management system for detailed engineering of a plant project in a system for managing a schedule of the plant project, the management system comprising:
a data management module configured to manage index data for assessing engineering maturity for the plant project;
an assessment module configured to assess engineering maturity of the plant project based on the index data and managing configured to manage a corresponding result; and
a schedule management module configured to change or manage a start date for a project process according to the corresponding result,
wherein the index data includes a plurality of index elements, each index element is divided into a plurality of stages different in level, and each level is given a weight according to the plurality of index elements.

15. A management program for detailed engineering of a plant project, in a system for managing a schedule of the plant project, stored in a medium to execute:
determining a start date for a process of a project for the plant project;
preparing an engineering maturity assessment data including index data;
determining a key milestone schedule including a key milestone time;
calculating a first engineering maturity assessment score at a contract time;
comparing the first engineering maturity assessment score with a first reference value,
calculating a second engineering maturity assessment score at the key milestone time;
comparing the second engineering maturity assessment score with a second reference value;
calculating a third engineering maturity assessment score at the start date; and
comparing the third engineering maturity assessment score with a third reference value,
wherein the process is performed according to the start date for the process of the project if the third engineering maturity assessment score is less than the third reference value.

16. The management method of claim 8, wherein
the category comprises each of a plurality of index elements reflecting characteristics of the category, the plurality of index elements are divided into a plurality of stages different in level, and each level may be given a weight according to the plurality of index elements.

17. The management method of claim 9, wherein
the category comprises each of a plurality of index elements reflecting characteristics of the category, the plurality of index elements are divided into a plurality of stages different in level, and each level may be given a weight according to the plurality of index elements.

18. The management method of claim 16, wherein
the weight is normalized such that an assessment score for all of the plurality of index elements is a maximum of 1,000.

19. The management method of claim 17, wherein
the weight is normalized such that an assessment score for all of the plurality of index elements is a maximum of 1,000.

20. The management method of claim 16, wherein
the third reference value is 300 points.
